(19) United States
(12) Patent Application Publication
(10) Pub. No.: US 2022/0210131 A1
(43) Pub. Date: Jun. 30, 2022

(54) SYSTEM AND METHOD FOR SECURE FILE AND DATA TRANSFERS

(71) Applicant: Herbert Hannah, Pomona, NY (US)

(72) Inventor: Herbert Hannah, Pomona, NY (US)

(21) Appl. No.: 17/697,661

(22) Filed: Mar. 17, 2022

Related U.S. Application Data
(60) Provisional application No. 63/162,380, filed on Mar. 17, 2021.

(51) Int. Cl. H04L 9/40; H04L 67/06

(52) U.S. Cl. CPC H04L 63/0272; H04L 67/06; H04L 63/0435; H04L 63/0236

(57) ABSTRACT

A system and method for secure and quantum resistant data transfer over a public wide area network. The method implemented within the system and included the steps of deploying a plurality of virtual network functions (VNFs) on a white box universal consumer premises equipment (uCPE) for secure and quantum resistant data transfer over a wide area network independent of internet protocols. The public wide area network can be internet.

### CROSS-REFERENCE TO RELATED APPLICATIONS

This application claims priority from the U.S. provisional patent application Ser. No. 63/162,380, filed on Mar. 17, 2021, which is incorporated herein by reference in its entirety.

### FIELD OF INVENTION

The present invention relates to a system and method for secure network connections, and more particularly, the present invention relates to a system and method that can utilize two or more independent internet connections, without IPsec protocol, for the fail-safe, secure, and efficient data file transfers.

### BACKGROUND

Secure network connections and file transfer have become essential for a variety of reasons, the primary reason is to protect data. Encryption of network packets is the most common way for securely sending data over a packet switched network, such as the internet. Internet Protocol Security (IPsec) is an industry standard protocol suite that is used to authenticate and encrypt the network packets sent over an internet protocol network. IPsec, also used in VPN, provides for data authentication, integrity, and confidentiality between nodes on an IP network. IPsec is implemented as IPsec tunnel mode and IPsec transport mode. In IPsec tunnel mode, two nodes act as a tunnel through a public network and cause encryption of both the IP header and the payload of a network packet.

The existing protocol suits, such as IPsec can provide secure data transfer between two nodes on an IP network, however, the efficiency of data transfer and reliability is significantly hampered. Moreover, ISPs and private routers sometimes choose connections that are substandard, resulting in high latency and unreliable connections that ate unable to redirect traffic if a path fails. The conventional and expensive WAN options like dedicated links, MPLS, or Virtual Private Networks (VPNs) lacks efficiency and suffer from drawbacks such as overhead, limited security control, scaling problems, management complexity, international restrictions, lack of cross carrier support and more.

Thus, a need is appreciated for a system and method that is devoid of the aforesaid drawbacks of existing protocol suits.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a system and method for securely, reliably, and efficiently transferring data on a wide area network.

It is another object of the present invention that the system and method can provide protection against cryptanalytic attack by a quantum computer.

It is still another object of the present invention that the system and method can provide stateless connectivity without requiring layer-based protocols and tunnels.

In one aspect, disclosed is a system and method for efficiently managing and orchestrating Virtual Network Functions (VNFs).

In one aspect, disclosed is system for secure and quantum resistant data transfer over a network, the system comprising a processor and a memory, the system configured to implement a method comprises the steps of deploying a plurality of virtual network functions (VNFs) on a white box universal consumer premises equipment (uCPE) for secure and quantum resistant data transfer over a wide area network independent of internet protocols. The wide area network is a public internet. The method further includes the steps of fragmenting a data file into fragments; and transmitting the fragments of the data file over a plurality of internet connections simultaneously. The method further comprises the steps of encrypting data at the sender's device using encryption keys; and sending the encrypted data, by the sender's device over the public internet, wherein the encryption keys are not transmitted with the encrypted data.

In one aspect, disclosed is a method for and quantum resistant data transfer over a network, the method implemented within a system comprising a processor and a memory, the method comprises the steps of deploying a plurality of virtual network functions (VNFs) on a white box universal consumer premises equipment (uCPE) for secure data transfer over a wide area network independent of internet protocols.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 shows a legacy network strategy, as in prior art.

FIG. 2 illustrates the network strategy implemented by the disclosed system and method, according to an exemplary embodiment of the present invention.

FIG. 3 is a block diagram showing the architecture of disclosed system, according to an exemplary embodiment of the present invention.

FIG. 4 is a block diagram illustrating the secure transport uCPE with orchestration, according to an exemplary embodiment of the present invention.

FIG. 5 is a schematic diagram showing the network architecture, according to an exemplary embodiment of the present invention.

FIG. 6 is another schematic diagram showing the network architecture between cloud services and enterprises/data centers, according to an exemplary embodiment of the present invention.

FIGS. 7A, 7B, and 7C shows an implementation of the disclosed system and method, according to an exemplary embodiment of the present invention.

### DETAILED DESCRIPTION

The accompanying figures, which are incorporated herein, form part of the specification and illustrate embodiments of the present invention. Together with the description, the figures further explain the principles of the present invention and to enable a person skilled in the relevant arts to make and use the invention.

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a Protocol Independent Encrypted Transport (PIET) system and method for implementing VNF Orchestration on a uCPE OS for monitoring and connectivity between geographically dispersed locations over any available infrastructure, including the public Internet. The disclosed system can securely support all kinds of network traffic including Unicast, Multicast, and Broadcast. Virtual network functions (VNF) are known in the art, such as SD-WAN, MPLS, and VPLS, and any such VNF known to a skilled person can be incorporated without departing from the scope of the present invention.

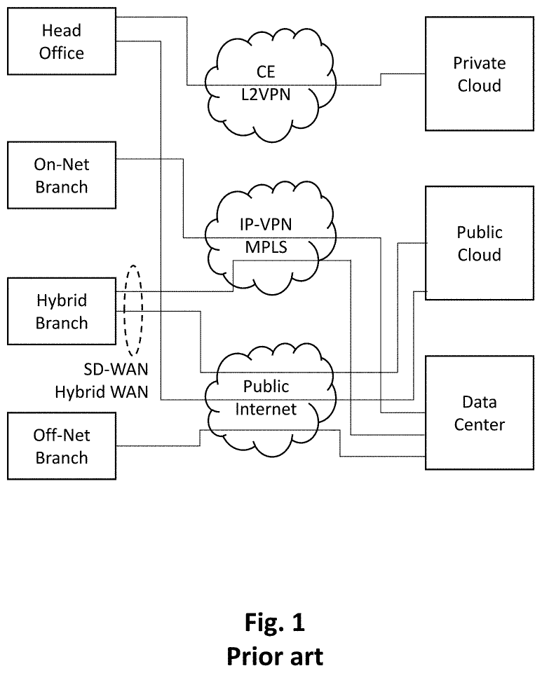

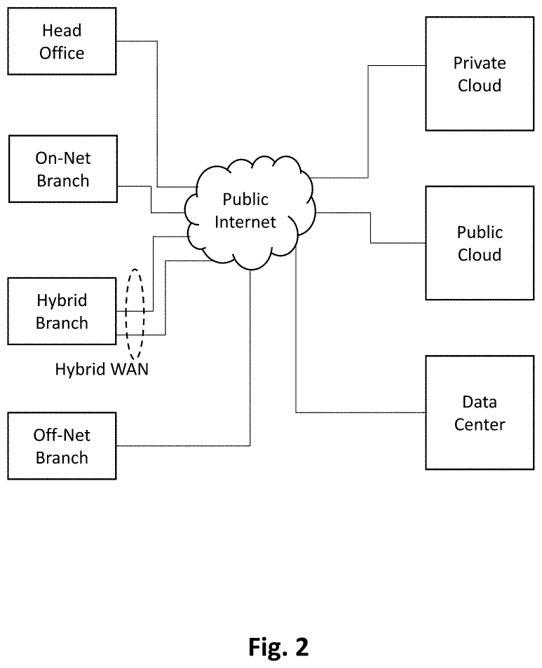

The disclosed PIET system can integrate security with the OS for flawless network orchestration management and security. Creating a solution like no other, a technology that can work with or without a control plane. The disclosed system and method can support transport across the public Internet which is now the most favorable WAN option for enterprises, service providers, and telco's as they shift away from old, conventional, expensive WAN options like dedicated links, MPLS, or Virtual Private Networks (VPNs). Referring to FIG. 1 which shows the legacy network strategy adopted by enterprises resulting in complex and costly network management. FIG. 2 illustrates the network architecture that can be implemented by the disclosed system using a public wide area network making it simple, manageable, and cost effective.

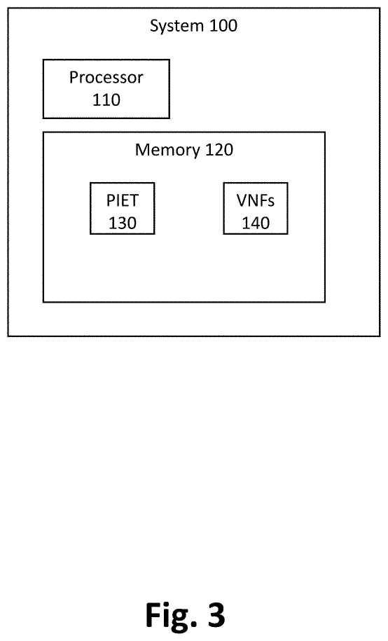

Referring to FIG. 3 which is a block diagram illustrating an architecture of the disclosed system 100. The system 100 can include a processor 110 and a memory 120. The processor can be any logic circuitry that responds to, and processes instructions fetched from the memory. The memory may include one or more memory chips capable of storing data and allowing any storage location to be directly accessed by the processor. The memory includes modules according to the present invention for execution by the processor to perform one or more steps of the disclosed methodology. The memory can include PIET module 130 which upon execution by the processor can provide for integrating security with the OS for flawless network orchestration management and security. The memory can further include virtual network functions 140 implemented by the system for IP independent data transfer.

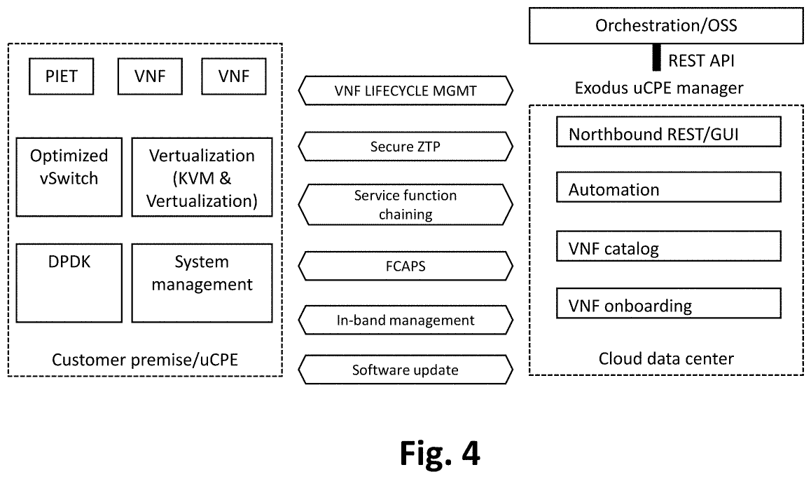

Referring to FIG. 4 which shows the secure transport uCPE with orchestration as implemented by the disclosed system and method. The disclosed system can allow for increased adoption of open standard cloud computing platform (Openstack) or non Openstack based uCPE. The disclosed system and method can incorporate ENEA, FlexiWAN, Ekinops, or other opensource or non-opensource SD-WAN for greater network security, easier management, less overhead and latency, and (QRSD-WAN) Quantum Resistant SD-WAN. The disclosed system can incorporate other VNFs to provide greater network security, easier management, less overhead and latency. The disclosed system can incorporate a cloud native management software from Ekinops, RADview, or other companies to provide greater network security, easier management, and less overhead and latency.

In certain embodiment, the disclosed system can add up the total bandwidth of the available internet connections. For example, two internet connections can be aggregated, such that a single file transfer is executed through all the available internet connections and/or ISPs simultaneously, thereby significantly increasing the speed. The disclosed fragmented multi-path delivery using multiple internet connections can ensure that best connections are utilized, thus reducing the latency significantly. Also, in the case, any of the available internet connections fails, the disclosed system can use available internet connections without effecting the availability and or having downtimes.

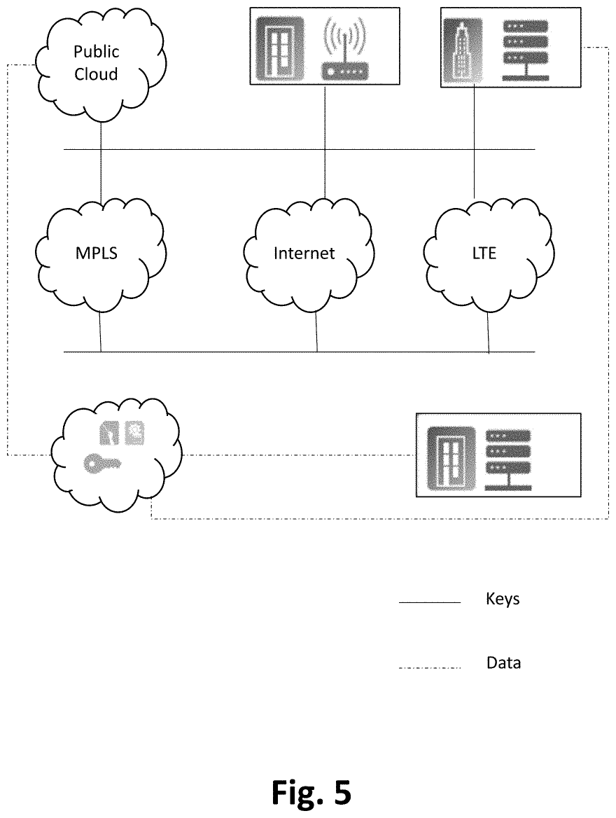

Referring to FIG. 5 which is a schematic diagram showing the distribution of keys on a public wide area network. For instance, even if a cloud provider offers end-to-end encryption, they may also maintain and have access to the keys which still requires a level of external trust. The disclosed system and method require that an organization manage its own keys, preventing the access to the keys to any third-party cloud provider. The disclosed system can separate encrypted data from encryption keys such that only the source node and the destination node can have access to the data. For example, the disclosed system and method can enable this by separating email content from the keys that secure it while encrypting the data from end-to-end, so that only the initial creator and intended consumer has access.

Enterprise data can also be exposed to the portal vendor itself. Though portal vendors will encrypt data at rest in their systems, they also hold the encryption keys, which means an attack that compromises the legacy vendor's network makes the client data more vulnerable. And even with TLS, the data is still vulnerable at several points throughout its lifecycle. Also, the portal solutions also come up short on key regulatory requirements and leave the enterprise open to unauthorized government surveillance. Agencies can subpoena the cloud provider and/or the portal vendor without informing the enterprise, getting access to private corporate data without consent. The disclosed system and method can separate the encryption keys from the encrypted data, so that only intended users have access to the data.

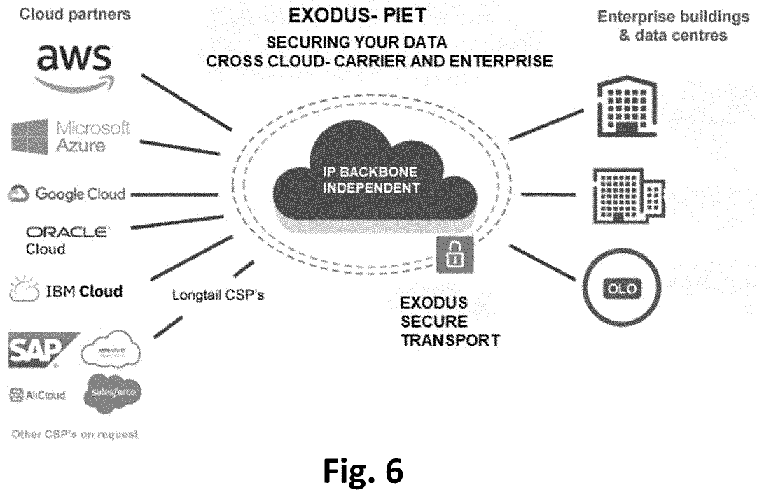

For instance, presently, an email provider can access the encrypted email content, however, the disclosed system can manage the encryption keys at layers 2, 3, and 4, such that the email provider has no access to the encryption keys and thus the data. Emails and files can encrypt before they leave the sender's computer and only decrypted when they reach the destination, the encryption keys are not passed across the carrier network keeping data protected wherever it is shared (in motion and at rest). The disclosed system and method use the same approach to protect other applications. Real-time communications, Salesforce or Workday data, or onsite files being migrated to the cloud can be encrypted throughout their journey to prevent interception. Again, referring to FIG. 5, session keys are not passed across the network like IKE (IPsec) or MKA (MACSEC). Master key is sent encrypted at commissioning, unique keys are generated by each transmitter. Shim passes information to identify each transmitter fragmented packet delivery is further secured so no packet contains all data. FIG. 6 illustrates certain implementation of the disclosed system and method.

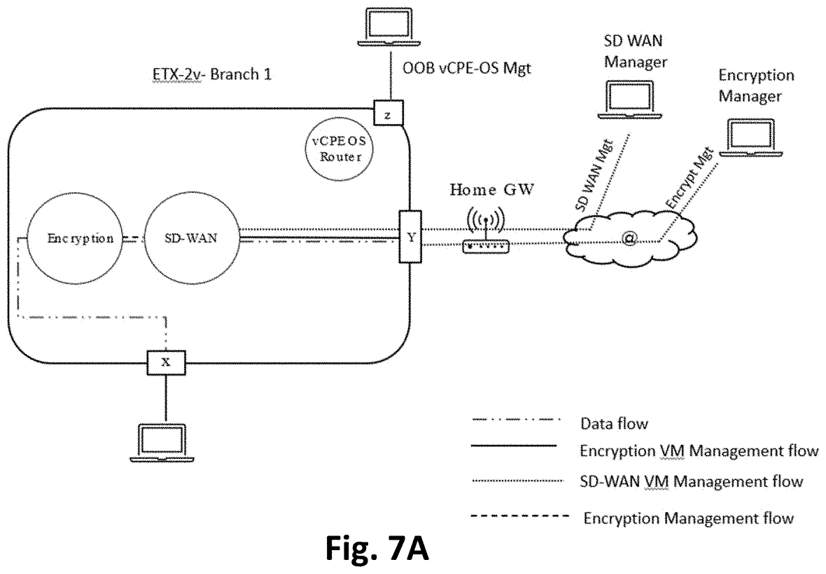

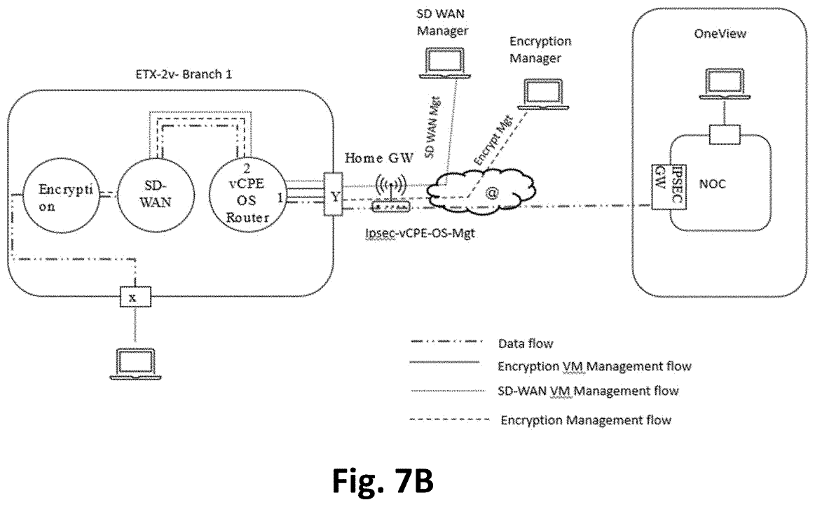

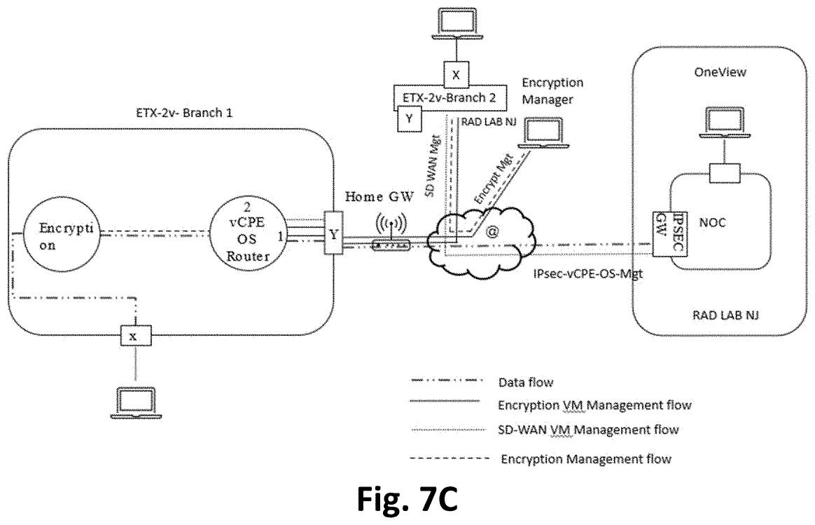

Referring to FIGS. 7A-7C which show certain implementation of the disclosed system and method. FIG. 7A shows the VNFs upload and configuration tests. In the test, each VNF and configuration of SD-Wan was provide access to encryption VNF. vCPE-OS was managed through OOB and separate interface. SD-WAN VNF receives all traffic from interface Y and is configured to provide access to the encryption VNF. FIG. 7B shows the vCPE-OS managed (through IPsec). FIG. 7 shows the Setup with vCPE-OS Management, vCPE-OS managed through Inband Management, vCPE-OS forward all incoming traffic (Except IPSec Tunnel traffic) to the FlexiWan, FlexiWan VNF will forward Encryption management traffic to the encryption VNF as for the Data traffic. Referring to FIG. 7C, which shows the use of vCPE-OS router instead of the SD-WAN. To setup with vCPE-OS Management; ToBeDefined:Routing between the different branches, vCPE-OS managed through Inband Management, vCPE-OS forward all incoming traffic (Except IPSec Tunnel traffic) to the Encryption.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A system for secure and quantum resistant data transfer over a network, the system comprising a processor and a memory, the system configured to implement a method comprises the steps of:
deploying a plurality of virtual network functions (VNFs) on a white box universal consumer premises equipment (uCPE) for secure and quantum resistant data transfer over a wide area network independent of internet protocols.

2. The system according to claim 1, wherein the wide area network is a public internet.

3. The system according to claim 2, wherein the method further comprises the steps of:
fragmenting a data file into fragments; and
transmitting the fragments of the data file over a plurality of internet connections simultaneously.

4. The system according to claim 3, wherein the method further comprises the steps of:
encrypting data at a sender's device using encryption keys; and
sending the encrypted data, by the sender's device over the public internet, wherein the encryption keys are not transmitted with the encrypted data.

5. A method for and quantum resistant data transfer over a network, the method implemented within a system comprising a processor and a memory, the method comprises the steps of:
deploying a plurality of virtual network functions (VNFs) on a white box universal consumer premises equipment (uCPE) for secure data transfer over a wide area network independent of internet protocols.

6. The method according to claim 5, wherein the wide area network is a public internet.

7. The method according to claim 6, wherein the method further comprises the steps of:
fragmenting a data file into fragments; and
transmitting the fragments of the data file over a plurality of internet connection simultaneously.

8. The method according to claim 7, wherein the method further comprises the steps of:
encrypting data at a sender's device using encryption keys; and
sending the encrypted data, by the sender's device over the public internet, wherein the encryption keys are not transmitted with the encrypted data.
